(19) United States
(12) Patent Application Publication
(10) Pub. No.: US 2026/0337522 A1
(43) Pub. Date: Oct. 29, 2026

(54) FOAM PRODUCING CLEANING COMPOSITION WITH ENHANCED FOAMING AND CLEANING EFFICACY

(71) Applicant: Venus Laboratories, Inc., Cypress, CA (US)

(72) Inventors: Jenna L. Arkin, Long Beach, CA (US); Ryan K. Hood, Huntington Beach, CA (US); Marlene Raigoza, Montebello, CA (US); Johanna Sandoval, Ontario, CA (US); James W. Davis, Lacey, WA (US); Samantha Hartman, Irvine, CA (US)

(21) Appl. No.: 19/659,720

(22) Filed: Apr. 27, 2026

Related U.S. Application Data
(60) Provisional application No. 63/796,272, filed on Apr. 28, 2025.

(51) Int. Cl. C11D 3/00; C11D 1/08; C11D 3/10; C11D 3/20; C11D 3/38; C11D 3/39; C11D 3/50; C11D 17/00; C11D 17/06

(52) U.S. Cl. CPC C11D 3/0094; C11D 1/08; C11D 3/10; C11D 3/2086; C11D 3/381; C11D 3/3902; C11D 3/505; C11D 17/0056; C11D 17/06; C11D 2111/14

(57) ABSTRACT

Provided herein are foam producing cleaning compositions in solid dry powder form such as a tablet that include a foaming system, a fragrance delivery system, and a natural pH indicating system. The foaming system includes citric acid, sodium bicarbonate, an oxygen-releasing composition, active yeast, and one or more surfactants. The active yeast, oxygen-releasing composition, and one or more surfactants work synergistically to produce thick and persistent foams, thereby enhancing foaming and cleaning efficacy.

### INCORPORATION BY REFERENCE TO ANY PRIORITY APPLICATIONS

Any and all applications for which a foreign or domestic priority claim is identified in the Application Data Sheet or Request as filed with the present application are hereby incorporated by reference in their entirety under 37 CFR 1.57.

This application claims benefit of U.S. Provisional Application No. 63/796,272, filed Apr. 28, 2025, entitled “FOAM PRODUCING CLEANING COMPOSITION WITH ENHANCED FOAMING AND CLEANING EFFICACY”, the content of which is incorporated herein by reference in its entirety.

### BACKGROUND

### Field

This disclosure generally relates to household cleaning compositions, and more particular, cleaning compositions that generate foam.

### Description of the Related Art

As consumer demand for bio-powered cleaning products continues to grow, there is an increasing need for bio-powered foaming products with improved cleaning and stain removal efficacy. Existing foaming products may lack sufficient foam thickness, persistence, or overall cleaning performance. Short foam persistence may result in inadequate contact time with treated surfaces, thereby reducing stain removal effectiveness and limiting the ability of active ingredients to act on stained areas. There remains a need for improved foaming cleansing compositions that provide enhanced cleaning efficacy with stable and persistent foam formation.

### SUMMARY

The present disclosure relates to a foam producing cleaning composition having longer lasting foams and increased foam formation. In some embodiments, the cleaning composition comprises yeast and an oxygen-releasing component. Catalytic activity of the yeast in combination with gas generated from the oxygen-releasing component can enable production of increased and more sustained foam formation. In one embodiment, the composition comprises 2-15 wt. % yeast; 5-40 wt. % peroxide; 15-35 wt. % sodium bicarbonate; 20-40 wt. % citric acid; and 2-15 wt. % one or more surfactants. The yeast can be an active yeast, such as active dry yeast strains Saccharomyces cerevisiae or Saccharomyces pastorianus. The peroxide can comprise sodium percarbonate. The one or more surfactants can comprise a sodium coco-derived surfactant, such as sodium cocoate.

In some embodiments, the composition comprises a fragrance delivery system. In one embodiment, the composition comprises 2-15 wt. % fragrance delivery system. The fragrance delivery system can include a fragrance carrier and a fragrance blend. In some embodiments, the fragrance carrier includes maltodextrin and/or cyclodextrin. In some embodiments, the fragrance blend and the fragrance carrier are present at a weight ratio of about 1:4.

In some embodiments, the cleaning composition forms a solution having a pH of about 5.0 to 5.3 when in contact with water. The cleaning composition can include a natural pH indicating system comprising one or more natural dyes that exhibit a color change in response to a change in pH. In one embodiment, the natural pH indicating system comprises a bilberry extract.

The cleaning composition can be in the form of a powder or a tablet. In some embodiments, the cleaning composition generates a foam having a persistence of more than 5 minutes when in contact with water. In some embodiments, the cleaning composition is a toilet bowl cleaner. The composition can be placed in a pouch made of a water-soluble film such as polyvinyl alcohol (PVA) and/or a cellulose-based material.

Certain embodiments of the present disclosure relate to a foaming toilet bowl cleaner in solid form, such as in powder or tablet form. The toilet bowl cleaner comprises an active yeast and oxygen-releasing component such as peroxide. The active yeast can be granulated shelf-stable dry yeast, such as Saccharomyces cerevisiae strain, Saccharomyces pastorianus strain, and/or other known strains. The toilet bowl cleaner dissolves when in contact with water, and the catalytic activity of the active yeast in combination with carbon dioxide released from the oxygen-releasing component results in the toilet bowl cleaner having increased foam production and longer lasting foaming. In some embodiments, the toilet bowl cleaner is formulated to dissolve in water and release sufficient carbon dioxide to form a foam and the active yeast increases the volume and duration of the foam. In one embodiment, the toilet bowl cleaner comprises 2-15 wt. % active yeast; 5-40 wt. % peroxide; 15-35 wt. % sodium bicarbonate; 20-40 wt. % citric acid; and 2-15 wt. % one or more surfactants. In some embodiments, the toil bowl cleaner further comprises 2-15 wt. % fragrance delivery system. The fragrance delivery system can include a fragrance carrier and a fragrance blend that are embedded in the toilet bowl cleaner. The fragrance carrier can comprise maltodextrin and/or cyclodextrin. In some embodiments, the toilet bowl cleaner further comprises a pH indicator, such as a natural pH indicator.

### DETAILED DESCRIPTION

Embodiments of compositions, articles, and methods of manufacture will now be described with reference to the accompanying FIGURES, wherein like numerals refer to like or similar elements throughout. Although several embodiments, examples and illustrations are disclosed below, it will be understood by those of ordinary skill in the art that the inventions described herein extend beyond the specifically disclosed embodiments, examples and illustrations, and can include other uses of the inventions and obvious modifications and equivalents thereof. The terminology used in the description presented herein is not intended to be interpreted in any limited or restrictive manner simply because it is being used in conjunction with a detailed description of certain specific embodiments of the inventions. In addition, embodiments of the inventions can comprise several novel features and no single feature is solely responsible for its desirable attributes or is essential to practicing the inventions herein described.

The disclosure herein provides various embodiments of a foam producing cleaning composition that generates a thick and persistent foam which clings to a surface upon contact with water. The disclosed foam producing cleaning composition can provide enhanced foaming and cleaning efficacy.

The foam producing cleaning composition may be in a dry solid form, for example, in the form of a powder, a tablet, a ball or various other configurations. In the solid dry form, the components of the foam producing cleaning composition can be stably preserved without reaction. In some embodiments, the foam producing cleaning composition can be in the form of a toilet bowl cleaner such as a toilet bomb. The components of the foam producing cleaning composition may be configured to dissolve in water and react immediately when in contact with water. For example, the components may begin reacting when in contact with water within about 1 second, 2 seconds, 3 seconds, 4 seconds, or within a range defined by any two of the preceding values.

Embodiments of the foam producing cleaning composition may include a foaming system, a fragrance delivery system, and a natural pH indicating system.

In some embodiments, the foaming system may include citric acid and sodium bicarbonate. Citric acid is a weak organic acid and can be used as a cleaning agent. Citric acid can help remove, for example, urine stains, soap scum, and mineral deposits. Sodium bicarbonate can be used as a mild abrasive to remove grime. Upon contact with water, citric acid and sodium bicarbonate dissolve and react to generate carbon dioxide (CO₂). The reaction can produce foam that enhances cleaning by removing dirt and stains from surfaces such as toilet bowl surfaces.

In some embodiments, the amount of the citric acid present in the foam producing cleaning composition may range from, for example, approximately 20 wt. % to approximately 45 wt. %, from approximately 23 wt. % to approximately 40 wt. %, from approximately 25 wt. % to approximately 35 wt. %, from approximately 27 wt. % to approximately 33 wt. %, or a value in a range defined by any of these values.

In some embodiments, the amount of the sodium bicarbonate present in the foam generating cleaning composition may range from, for example, approximately 10 wt. % to approximately 35 wt. %, from approximately 12 wt. % to approximately 33 wt. %, from approximately 15 wt. % to approximately 30 wt. %, from approximately 17 wt. % to approximately 24 wt. %, or a value in a range defined by any of these values.

The amount of citric acid and sodium bicarbonate can be chosen such that the finished foam producing cleaning composition has an acidic pH. In some embodiments, the amount of citric acid may be greater than the amount of sodium bicarbonate, creating an acid-biased composition. This acid bias can enhance cleaning performance, particularly in removing and dissolving urine stains, hard water stains, and mineral deposits. When in contact with water, the foaming system may exhibit an acidic pH. In some embodiments, the foam producing cleaning composition can be a toilet bowl cleaner and when in contact with water, may form a solution having a pH of 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, or within a range defined by any two of the preceding pH values. In some embodiments, the foam producing cleaning composition, when in contact with water, may form a solution having a pH of about 3.5 to about 6.0, about 4.0 to about 5.5, or about 5.0 to about 5.3.

In some embodiments, the foaming system may include an oxygen-releasing composition. The amount of the oxygen-releasing composition present in the foam producing cleaning composition, such as a toilet bowl cleaner, may range from, for example, approximately 5 wt. % to approximately 40 wt. %, from approximately 10 wt. % to approximately 35 wt. %, from approximately 20 wt. % to approximately 33 wt. %, from approximately 24 wt. % to approximately 30 wt. %, or a value in a range defined by any of these values. The oxygen-releasing composition can generate oxygen when in contact with water.

In some embodiments, the oxygen-releasing composition may comprise a peroxide. In some embodiments, the foam producing cleaning composition may comprise sodium percarbonate. When in contact with water, sodium percarbonate can decompose to release hydrogen peroxide (H₂O₂), which then breaks down into water and oxygen. The oxygen-releasing action can break down stubborn grime. In some embodiments, the sodium percarbonate may be uncoated sodium percarbonate. Uncoated sodium percarbonate refers to sodium percarbonate particles without an outer coating. Uncoated sodium percarbonate can readily dissolve in water and rapidly release hydrogen peroxide, resulting in a fast oxygen release rate. In some embodiments, the sodium percarbonate may be coated sodium percarbonate. Coated sodium percarbonate may include a sodium sulfate outer coating. The sodium sulfate outer coating can slow the reactivity of the sodium percarbonate and reduce the oxygen release rate. The type and amount of sodium percarbonate may be selected to control and achieve a desired oxygen release rate. In some embodiments, the amount of sodium percarbonate present in the foam producing cleaning composition may range from, for example, approximately 10 wt. % to approximately 40 wt. %, from approximately 12 wt. % to approximately 35 wt. %, from approximately 15 wt. % to approximately 30 wt. %, from approximately 17 wt. % to approximately 28 wt. %, or a value in a range defined by any of these values. In some embodiments, the foaming system may not include an oxygen-releasing composition.

In some embodiments, the foaming system may include yeast, for example, active yeast. The amount of yeast present in the foam producing cleaning composition may range from, for example, approximately 2 wt. % to approximately 15 wt. %, from approximately 3 wt. % to approximately 12 wt. %, from approximately 4 wt. % to approximately 10 wt. %, or a value in a range defined by any of these values. The yeast can be granulated shelf-stable active dry yeast, such as Saccharomyces cerevisiae strain, Saccharomyces pastorianus strain, and/or other strains.

In one embodiment, active yeast contains enzyme catalase, which can catalyze the oxygen-releasing action. Active yeast can accelerate the oxygen-releasing action, for example, by accelerating the decomposition of sodium percarbonate to produce hydrogen peroxide (H₂O₂). As described above, upon contact with water, citric acid and sodium bicarbonate can react to generate CO₂, thereby providing an initial generation of gas and bubble formation. H₂O₂, for example, as generated from the peroxide, can further be decomposed in the presence of catalase in the active yeast to generate oxygen (O₂), thereby providing a more sustained release of gas. The combined generation of gas from the oxygen-releasing composition and the catalytic activity of the active yeast can provide increased bubble formation and a more sustained release of gas. In this manner, the active yeast and the oxygen-releasing composition may act in combination, where CO₂ generated from the acid-bicarbonate reaction and the O₂ generated from the peroxide decomposition together contribute to enhanced foam formation and improved foam persistence. In some embodiments, the presence of active yeast can promote rapid initiation of the oxygen-releasing action upon contact with water, thereby providing rapid bubble formation. Additionally, selection of active yeast having relatively high catalase activity may further increase the rate of gas generation. Upon contact with water, the oxygen-releasing action can start almost immediately, for example, within about 1 second, 2 seconds, 3 seconds, 4 seconds, 5 seconds, or within a range defined by any two of the preceding values.

In some embodiments, the active yeast may be a yeast including high-level catalase. However, it is also contemplated that the yeast may be another suitable type of yeast that can accelerate the oxygen-releasing action.

In some embodiments, the foaming system may include one or more surfactants. The surfactant(s) can stabilize foam, for example, by lowering surface tension. The surfactant(s) can also enhance cleaning efficacy. For example, surfactant(s) can enhance cleaning efficacy by facilitating removal of soils, including organic residues, mineral deposits, and other contaminants, from a surface, e.g., a toilet bowl surface. Surfactant(s) may further aid in maintaining such soils in a dispersed state within an aqueous medium to reduce redeposition. In this manner, inclusion of the surfactant(s) can improve overall cleaning performance of the cleaning composition. The one or more surfactants may include a sodium coco-derived surfactant. The one or more surfactants may include sodium cocoate. The amount of the one or more surfactants present in the foam producing cleaning composition may range from, for example, approximately 2 wt. % to approximately 15 wt. %, from approximately 4 wt. % to approximately 12 wt. %, from approximately 6 wt. % to approximately 10 wt. %, or a value in a range defined by any of these values.

Without wishing to be bound by theory, the inventors have found that the addition of yeast, an oxygen-releasing composition, and one or more surfactants described herein provides enhanced cleaning and stain removal efficacy. The active yeast, oxygen-releasing composition, and one or more surfactants can work synergistically to rapidly produce a thick and persistent foam. When in contact with water, the disclosed foam generating cleaning composition such as a foaming toilet bowl cleaner can begin generating foam almost immediately and produce a thick and persistent foam. The maximum foam height produced by the foaming toilet bowl cleaner may be, for example, at least 0.2 cm, at least 0.3 cm, at least 0.4 cm, at least 0.5 cm, at least 0.6 cm, at least 0.7 cm, at least 0.8 cm, at least 0.9 cm, at least 1 cm, at least 1.1 cm, at least 1.2 cm, at least 1.3 cm, at least 1.4 cm, at least 1.5 cm, at least 1.6 cm, at least 1.7 cm, or within a range defined by any two of the preceding values. Additionally, the foam producing cleaning composition can generate a foam having a persistence of, for example, more than 4 minutes, more than 5 minutes, more than 6 minutes, or more than 7 minutes, or within a range defined by any two of the preceding values. Foam persistence indicates how long the foam clings to a surface such as a toilet bowl surface, allowing active ingredients (e.g.: citric acid and sodium bicarbonate) to stay in contact with stains and/or grime for longer, improving cleaning and stain removal efficacy. The inventors have found that the foam produced by the disclosed composition is relatively thicker (e.g.: having greater maximum foam height) and more persistent (e.g.: having longer persistence) than traditional foam producing cleaning composition, for example, compositions that do not include the addition of yeast and an oxygen-releasing composition.

In some embodiments, the time from foam formation to maximum foam height may be about 80 seconds, 90 seconds, 100 seconds, 110 seconds, 120 seconds, 130 seconds, 140 seconds, 150 seconds, 160 seconds, or 170 seconds, or within a range defined by any two of the preceding values.

In some embodiments, the foam producing cleaning composition may have a pH at a 5-minute time point after contact with water of 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, or within a range defined by any two of the preceding pH values. In some embodiments, the foam producing cleaning composition such as a foaming toilet bowl cleaner, when in contact with water, may form a solution having a pH of about 4.0 to about 6.0, about 4.3 to about 5.8, or about 5.0 to about 5.6.

Embodiments of foam producing cleaning compositions may further include a fragrance delivery system. The fragrance system can be used to cover the smell of yeast.

In some embodiments, the fragrance delivery system may include a fragrance blend and a fragrance carrier. The fragrance delivery system can help stabilize and control fragrance release at the point of ingredients activation, for example, when the foaming toilet bowl cleaner is in contact with water. The amount of the fragrance delivery system present in the foaming toilet bowl cleaner may range from, for example, approximately 1 wt. % to approximately 25 wt. %, from approximately 3 wt. % to approximately 20 wt. %, or from approximately 5 wt. % to approximately 15 wt. %, or a value in a range defined by any of these values, or higher.

In some embodiments, the fragrance blend may comprise fragrance oil derived from one or more of litsea, eucalyptus, lemongrass, peppermint, tea tree, and mixtures thereof. In some embodiments, the fragrance carrier may comprise maltodextrin and/or cyclodextrin. The fragrance carrier may be in the form of a powder. Maltodextrin can hold fragrance by absorption or surface coating. Cyclodextrin can encapsulate fragrance molecules within its inside cavity. In some embodiments, the fragrance blend and the fragrance carrier may be present at a weight ratio of about 1:4. The fragrance blend and the fragrance carrier may also be present in another suitable weight ratio selected to provide a particular scent level.

In some embodiments, the fragrance system may be produced by mixing the fragrance blend with the fragrance carrier and drying the mixture of the fragrance blend and the fragrance carrier. An example method of producing the fragrance system may include providing a fragrance carrier, adding fragrance oil, mixing the fragrance blend with the fragrance carrier, and drying the mixture. The mixture may be air dried for 30 minutes or dried in a low oven at 120 °F for about 10-15 minutes. The method of producing the fragrance system may optionally include pre-mixing the fragrance with 1-2 drops of ethanol.

Embodiments of foam generating cleaning composition such as a foaming toilet bowl cleaner or toilet bomb may further include a natural pH indicating system. In some embodiments, the natural pH indicating system may include one or more natural dyes that can exhibit a color change in response to pH variation. Suitable natural dyes may include natural color extracts such as bilberry extract and butterfly pea flower, and other natural colorants such as spinach extract and spirulina extract. The amount of natural dyes present in the foaming toilet bowl cleaner may range from, for example, approximately 0.5 wt. % to approximately 10 wt. %, from approximately 1 wt. % to approximately 8 wt. %, or from approximately 2 wt. % to approximately 6 wt. %, or a value in a range defined by any of these values. In some embodiments, the natural pH indicating system may include bilberry extract. Bilberry extract, a natural source of anthocyanins, may exhibit a color change in response to pH variation. The natural pH indicating system can be configured to provide a visible color change during the cleaning process, thereby providing a visual indicator of active performance to the user. For example, the foaming toilet bowl cleaner may exhibit a purple color in the dry state and change to pink when citric acid and sodium bicarbonate react upon contact with water. An example method of producing a foam producing cleaning composition may include adding approximately 0.1 wt. % bilberry extract to the foaming system and the fragrance system, and mixing the foaming system, the fragrance system, and the natural pH indicating system to form a homogeneous mixture.

In some embodiments, the foam producing cleaning composition is substantially free of bleach, harsh chemicals, and overpowering chemicals.

In some embodiments, a foaming toilet bowl cleaner is provided may comprise a foam producing cleaning composition as disclosed above and a pouch. The pouch may comprise a polymer. The polymer may be polyvinyl alcohol (“PVA”). PVA can dissolve in water. In other embodiments, the polymer may be or may include a cellulose-based material. The polymer may be in the form of a water-soluble film. The foam producing cleaning composition may be encapsulated within the pouch. The pouch can dissolve completely upon contact with water, releasing the foam producing cleaning composition into the toilet bowl. In some embodiments, the pouch may dissolve in water in about 5-60 seconds, for example, in about 5-10 seconds, in about 10-15 seconds, in about 15-20 seconds, in about 20-25 seconds, in about 25-30 seconds, in about 25-30 seconds, in about 30-35 seconds, in about 35-40 seconds, in about 40-45 seconds, in about 45-50 seconds, in about 50-55 seconds, in about 55-60 seconds, or a value in a range defined by any of these values.

### EXAMPLES

### Example 1

Materials used in preparing the compositions described herein may be made by known methods or are commercially available. It is also possible to make use of variants which are themselves known to those of ordinary skill in this art, but are not mentioned in greater detail. The skilled artisan given the literature and this disclosure is well equipped to prepare the formulations of the instant application.

Table 1 provides an illustrative composition of the foam producing cleaning composition. The components are presented in Table 1 as weight percentages relative to the total weight of the foam producing cleaning composition.

TABLE 1
Content of a non-limiting foam
producing cleaning composition.

| | Amount |
|---|---|
| Ingredient | (wt. %) |
| Citric acid | 25-40 |
| Sodium bicarbonate | 15-30 |
| Sodium percarbonate | 15-30 |
| Active yeast | 2-10 |
| Sodium coco-derived | 2-15 |
| surfactant (SCI) | |
| Fragrance system | 2-16 |

When dissolved in water, the foam producing cleaning composition produces longer lasting and increased amount of foam. Not wishing to be bound by theory, the inventors believe that the combined generation of gas from sodium percarbonate and the catalytic activity of the active yeast help provide increased bubble formation and a more sustained release of gas.

### CERTAIN TERMINOLOGY

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

What is claimed is:

1. A foam producing toilet bowl cleaning composition comprising:
2-15 wt. % yeast, the yeast comprising shelf-stable, active dry yeast;
10-40 wt. % sodium percarbonate;
20-40 wt. % citric acid;
2-15 wt. % one or more surfactants; and
a pH indicating system comprising a natural pH indicator;
wherein the yeast catalyzes decomposition of the sodium percarbonate to generate sufficient gas upon contact with water such that an interaction of the yeast with the sodium percarbonate during the decomposition increases volume and duration of foam formation when the composition is dissolved in water.

2. The foam producing toilet bowl cleaning composition of claim 1, wherein the active dry yeast comprises Saccharomyces cerevisiae strain.

3. The foam producing toilet bowl cleaning composition of claim 1, wherein the active dry yeast comprises Saccharomyces pastorianus strain.

4. The foam producing toilet bowl cleaning composition of claim 1, wherein the one or more surfactants comprises a sodium coco-derived surfactant.

5. The foam producing toilet bowl cleaning composition of claim 4, wherein the one or more surfactants comprises sodium cocoate.

6. The foam producing toilet bowl cleaning composition of claim 1, further comprising a fragrance delivery system comprising a fragrance blend and a fragrance carrier.

7. The foam producing toilet bowl cleaning composition of claim 6, wherein the amount of the fragrance delivery system in the cleaning composition is 2-15 wt. %.

8. The foam producing toilet bowl cleaning composition of claim 6, wherein the fragrance carrier comprises maltodextrin and/or cyclodextrin.

9. The foam producing toilet bowl cleaning composition of claim 6, wherein the fragrance blend and the fragrance carrier are present at a weight ratio of about 1:4.

10. The foam producing toilet bowl cleaning composition of claim 1, wherein the cleaning composition is in the form of a powder or a tablet.

11. The foam producing toilet bowl cleaning composition of claim 1, wherein the cleaning composition generates a foam having a persistence of more than 5 minutes when in contact with water.

12. The foam producing toilet bowl cleaning composition of claim 1, wherein the cleaning composition forms a solution having a pH of about 5.0 to about 5.3 when in contact with water.

13. The foam producing toilet bowl cleaning composition of claim 1, wherein the pH indicating system comprises bilberry extract.

14. A foam producing cleaning composition comprising:
a) a foaming system comprising:
20-40 wt. % citric acid;
15-35 wt. % sodium bicarbonate;
10-40 wt. % peroxide;
2-15 wt. % active yeast; and
2-15 wt. % one or more surfactants; and
b) a natural pH indicating system.

15. The foam producing cleaning composition of claim 14, wherein the active yeast comprises Saccharomyces cerevisiae strain.

16. The foam producing cleaning composition of claim 14, wherein the active yeast comprises Saccharomyces pastorianus strain.

17. The foam producing cleaning composition of claim 14, wherein the peroxide comprises sodium percarbonate.

18. The foam producing cleaning composition of claim 14, wherein the cleaning composition forms a solution having a pH of about 5.0 to about 5.3 when in contact with water.

19. The foam producing cleaning composition of claim 14, wherein the natural pH indicating system comprises bilberry extract.

20. A toilet bowl cleaner comprising:
a tablet comprising sodium bicarbonate, citric acid, active yeast, and sodium percarbonate, wherein the tablet is configured to dissolve in water and release sufficient carbon dioxide to form a foam such that the active yeast increases a volume and a duration of the foam.
